(19) United States
(12) Patent Application Publication
(10) Pub. No.: US 2015/0320025 A1
(43) Pub. Date: Nov. 12, 2015

(54) Downrigger And Spreader Assembly

(71) Applicants: Nicolas R. Pruett, Colorado Springs, CO (US); Adin D. Pruett, Colorado Springs, CO (US)

(72) Inventors: Nicolas R. Pruett, Colorado Springs, CO (US); Adin D. Pruett, Colorado Springs, CO (US)

(21) Appl. No.: 14/275,068

(22) Filed: May 12, 2014

(51) Int. Cl. A01K 91/08; A01K 91/053

(52) U.S. Cl. CPC A01K 91/08; A01K 91/053

(57) ABSTRACT

A fishing downrigger and spreader assembly comprising a flat spreader plate having inner and outer mutually parallel planar surfaces and leading and trailing edges where superior and inferior spaced apart apertures for connection to cables are proximate the leading edge and where the trailing edge has superior and inferior spaced apart apertures for releasable connecting fishing line release clips and including an extensible rod one end of which is pivotally mounted to the outer planar surface of the spreader plate and the other end of which carries a fishing line release clip.

The present invention relates to fishing devices and more particularly to a combination for trolling with a downrigger and line spreaders.

### BACKGROUND

Fishing devices exist for maximizing the spread or lateral distribution of multiple fishing lines from a boat while trolling. Some use planning boards to stabilize the positioning of fishing lines while trolling while others utilize poles of varying lengths to accomplish variations in the distribution of fishing lines. The object of the present invention is to provide a stable platform from which a predictable position of fishing lines is established both in respect to the water depth at which the platform is used and in respect to the horizontal placement of fishing lines in relation to the boat and a downrigger assembly.

### DESCRIPTION OF PRIOR ART

In three instances of prior art. U.S. Pat. No. 4,920,687 issued to Barnett, U.S. Pat. No. 5,444,936 issued to McDonald, and U.S. Pat. No. 5,189,827 to Mrozek, rods or wires are used which extend from a planing board to provide for the lateral spread of terminal fishing lines from the planing board. In all of these devices the planing board is attached to a primary fishing line and when retrieving a fish from one line the entire planing board with associated attachments, hooks and attractants must be retrieved. These devices limit the experience of feeling a fighting fish.

In U.S. Pat. No. 8,572,887 issued to Adelman a luring dredge is employed. Here rods extend from a hub assembly onto which terminal hooks may be placed. This apparatus accomplishes the spread of terminal hooks but does not prevent rotation of the assembly, which would result in line entanglement.

In U.S. Pat. No. 7,296,377 issued to Wilcox a combined outrigger holder and fishing rod holder comprise an adjustable device that allows for varying degrees of spread of the fishing lines.

U.S. Pat. No. 4,901,469 issued to Murray utilizes a mounting system secured to a boat wherein the system supports multiple outriggers and provides for the spread of multiple fishing lines at predetermined depths. Modifications to the boat are required, and the management of the multiple downrigger devices is a significant factor in its operation.

A horizontally opposed downrigger assembly is disclosed in U.S. Pat. No. 8,683,735 issued to Figari. This invention provides for the spread of a plurality of lines and requires the addition of the assembly to a fishing boat.

### SUMMARY OF THE PRESENT INVENTION

The present invention provides a fishing device for use during trolling which allows for the use of multiple fishing lines wherein a maximum spread, or distance between, the lines is attained while at the same time using a single downrigger cable, which is connected to a platform or spreader plate. An extendable rod is attached to the spreader plate which acts as an outrigger. The plate and rod allow for multiple fishing lines to be trolled parallel to one another at a predetermined water depth. Hydrostatic water pressure against the plate created during tolling maintains the position of the plate complimentary to the water current and a lead downrigger weight maintains the plate at a desired fishing depth. The plate is of a size to offset force moments on the plate by the extendable rod in its fully extended position, which is the position in which maximum spread between fishing lines is attained. The adjustable rod mount allows for adjustment of the angle at which the rod extends from the plate, the desired degree of spread between lines, and for collapsing the pole such that it rests parallel to the plane of the plate for storage.

### DESCRIPTION OF THE DRAWINGS

FIG. 1 is a starboard side view of a representative fishing boat with the apparatus of the present invention deployed in the water below the boat and showing the full planar surface of the spreader plate.

FIG. 2 is an overhead view of the fishing boat of FIG. 1 showing two fishing poles mounted on the stern of the boat and showing the top edge view of the spreader plate deployed in the water below the surface.

FIG. 3, is an enlarged perspective view of the spreader plate.

FIG. 4 is a perspective view of the mounting holder for the extendable rod shown in its unlocked position capable of being rotated.

FIG. 5 is a perspective view of the mounting holder for the extendable rod shown in its locked position.

### DETAILED DESCRIPTION OF THE INVENTION

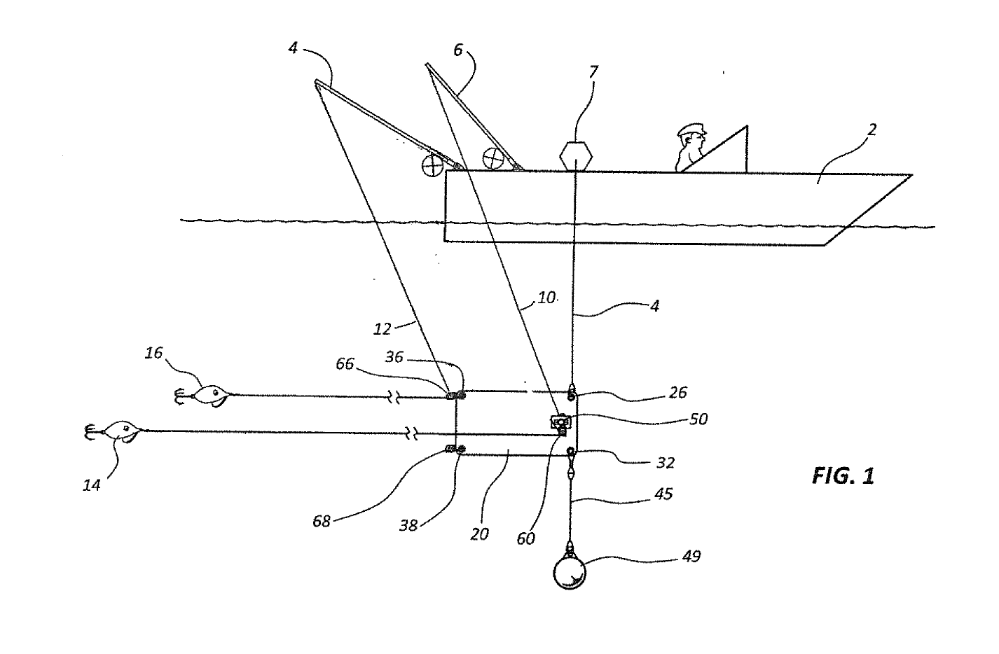

The combination downrigger and spreader assembly of the present invention is best understood generally by reference to the side view of FIG. 1 where a trolling fishing boat 2 is shown carrying fishing poles 4 and 6 having respective lines 12 and 10 and associated lures 16 and 14 disposed in the water on the starboard side of the boat.

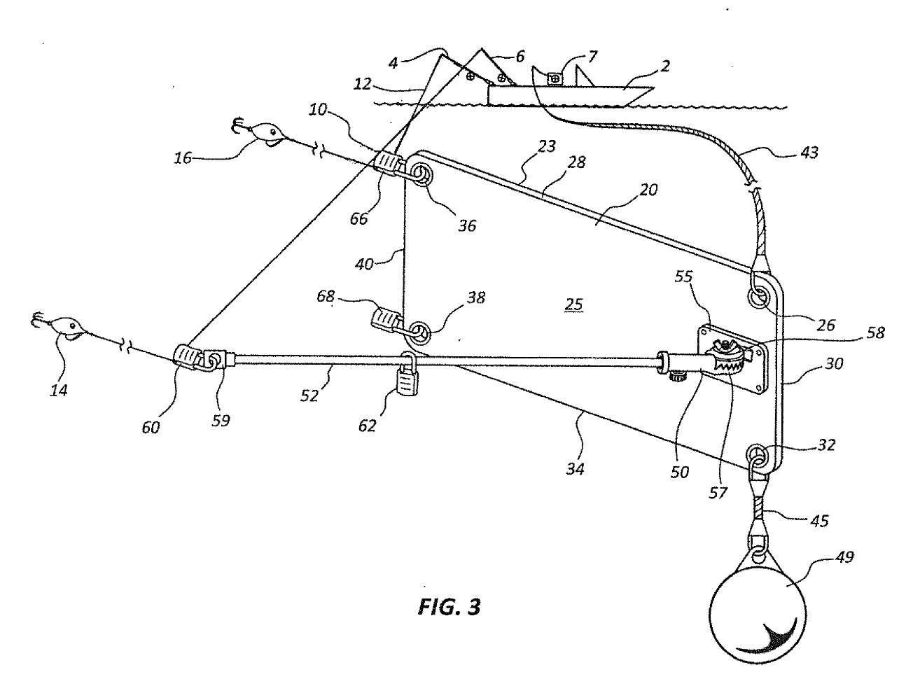

In order to combine the functions of a downrigger and a line spreader, a spreader plate 20 is provided, as shown in detail in FIG. 3. Preferably, the spreader plate is flat and rigid and has a rectangular shape with inner and outer mutually parallel planar surfaces 23 and 25. Apertures, or other forms of a fastening device, are provided at the four corners of the rectangular plate 20. An aperture 26 is positioned along the superior edge 28 and proximate the leading edge 30. Similarly, an aperture 32 is disposed along the inferior edge 34 and proximate the leading edge 30 of the spreader plate. Similar apertures 36 and 38 are placed near the trailing edge 40 of the spreader plate proximate the respective superior and inferior edges.

The leading edge apertures 26 and 32 provide respective attachment points for the distal end of a downrigger cable 43 and the downrigger weight retaining cable 45. The proximate end of the downrigger cable is attached to a conventional downrigger reel 7 secured to the fishing boat 2. The weight retaining cable 45 connects a conventional downrigger weight 49 to the leading edge of the spreader plate to position the plate at a desired fishing depth.

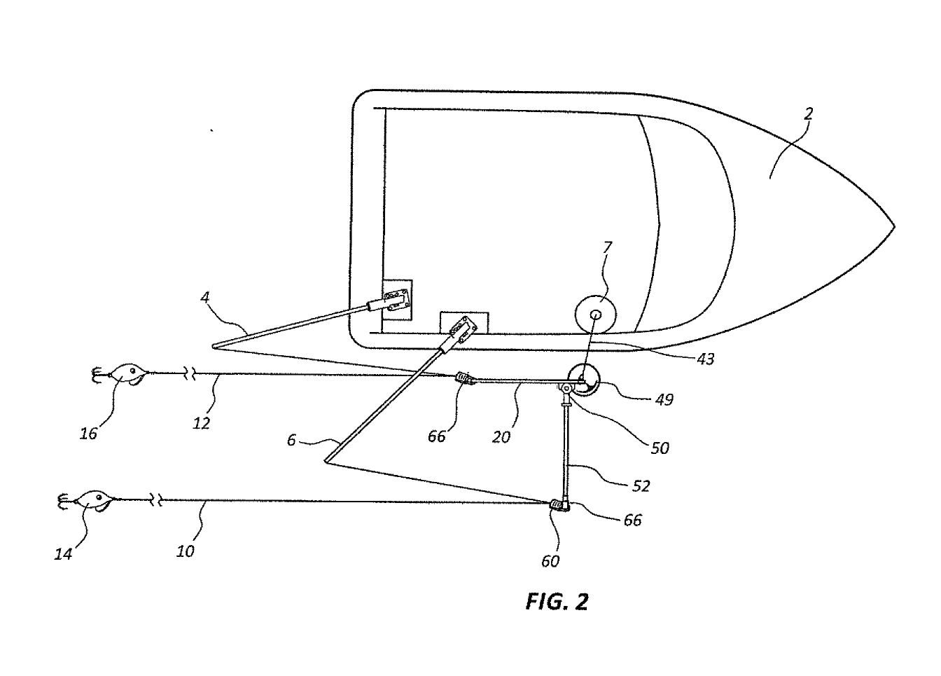

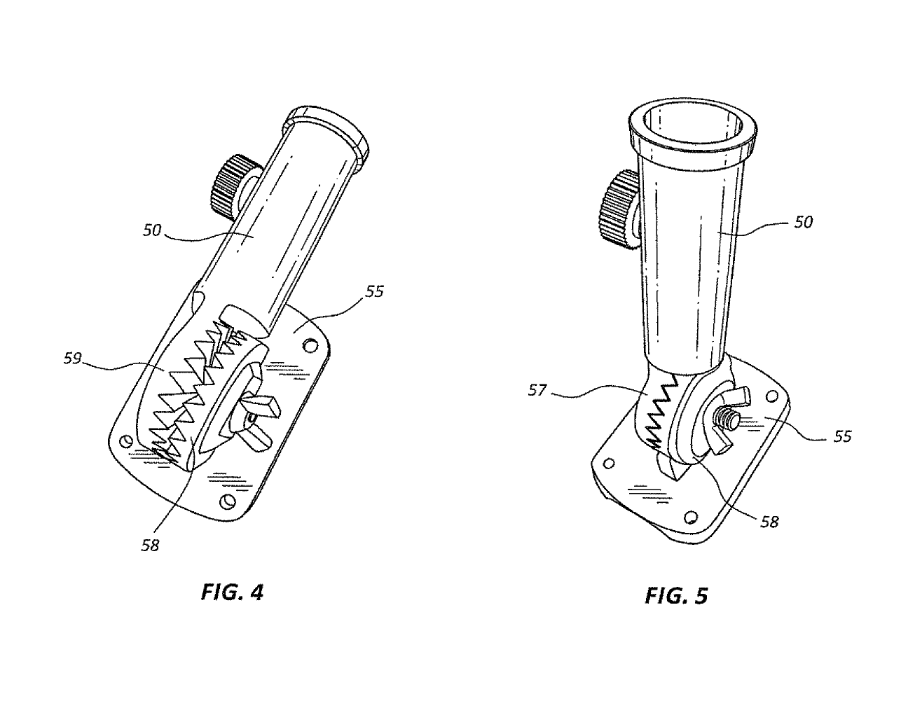

Securely attached to the outer planar surface 25 of the spreader plate 20 and proximate its leading edge 30 is attached a pivotal tube 50 that holds the proximate end of a telescoping extension rod 52. The pivotal tube and its mounting base 55 are similar in construction to a conventional flag holder having rotatable and interlocking mutually opposed teeth 57 and 58 that are separable to allow pivotal movement of the attached tube 50, as shown in FIG. 4. The holder's teeth may be locked into mutual engagement, as shown in FIG. 5, to seize the tube at a desired angle from the planar surface 25 of the spreader plate 20. When mounted within the pivotal tube 50, the extension rod 52 can be adjusted from a position that is parallel to the extension plate 20 (for storage) to one where the rod forms an angle of ninety degrees from the plate, as shown best in FIG. 2.

In connection with a description of the telescopic extension rod 52, it is noted that the length of the rod and the surface size of the plate 20 are interrelated. The longer the rod, the greater the force moment is on the plate 20, which requires a greater plate surface area to counteract the force moment of the rod in order to maintain the plane of the plate in longitudinal alignment with the course of the boat 2.

The distal end 59 of the extension rod is adapted to receive and support a line release clip 60, similar to a line clip used in conventional downrigger assemblies to releasably attach an intermediate section of a fishing line to the downrigger cable.

Additional line release clips 62 may be attached to the extension rod 52 at one or more points intermediate the ends of the rod.

The superior trailing edge aperture 36 is positioned and adapted to also mount a line release clip 66. The inferior trailing edge aperture 38 is positioned to mount a line release clip 68 which, when the spreader plate 20 is deployed on the port side of the fishing boat 2 the plate will be upside down from its position on the starboard side, as illustrated in FIGS. 2 and 3. The clip 68 will then be on the superior side of the plate 20 and in proper position to be attached to one of the fishing lines depending from the boat's port side.

Operation of the combination is illustrated in FIGS. 1 and 2. As stated earlier, the object of the assembly is to keep separated multiple fishing lines deployed from the same side of a trolling fishing boat while simultaneously enjoying the benefits of a downrigger that will take the fishing tackle to the desired depth. As seen in FIGS. 1 and 2, the spreader plate 20 is positioned at the desired depth by adjusting the length of the downrigger cable 43 with the downrigger reel 7. Fishing line 10 is releasably attached to the release clip 60 on the distal end of the extension rod 52. Fishing line 12 is attached to the release clip 66 connected to the superior trailing edge aperture 36, thus creating significant separation between the lines 10 and 12, as best seen in FIG. 2.

We claim:

1. A downrigger and spreader assembly comprising,
a spreader plate having inner and outer mutually parallel planar surfaces and leading and trailing edges, said leading edge having superior and inferior spaced apart means for connection to cables and said trailing edge having superior and inferior spaced apart means for connection,
a rigid extension rod having proximal and distal ends,
means for pivotally connecting the proximal end of the rod to the outer planar surface of the spreader plate.

2. The combination of claim 1 and further including,
a downrigger cable attached to the superior leading edge aperture, and
a downrigger weight attached to the inferior leading edge aperture.

3. The combination of claim 1 and further including,
line release clip means attached to at least the superior trailing edge aperture and the distal end of the extension rod for releasably securing a fishing line.

4. The combination of claim 3 where the leading and trailing edge connecting means are apertures.

5. A downrigger and spreader assembly comprising,
a plurality of line release clips,
a spreader plate having inner and outer mutually parallel planar surfaces and leading and trailing edges, said leading edge having superior and inferior spaced apart means for connection to cables and said trailing edge having superior and inferior spaced apart means for connection to the line release clips,
a rigid extension rod having proximal and distal ends,
means pivotally connecting the proximal end of the rod to the outer planar surface of the spreader plate,
means disposed at the distal end of the extension rod for connecting a line release clip,
a downrigger cable secured to the connecting means at the superior leading edge of the spreader plate,
a downrigger weight secured to the connecting means at the inferior leading edge of the spreader plate.

6. A downrigger and spreader assembly comprising,
a plurality of line release clips,
a spreader plate having inner and outer mutually parallel planar surfaces and leading and trailing edges, said leading edge having superior and inferior spaced apart means for connection to cables and said trailing edge having superior and inferior spaced apart means for connection to the line release clips,
a rigid extension rod having proximal and distal ends,
means for pivotally connecting the proximal end of the rod to the outer planar surface of the spreader plate,
a line release clip disposed at the distal end of the extension rod.
